(19) United States
(12) Patent Application Publication
(10) Pub. No.: US 2019/0363673 A1
(43) Pub. Date: Nov. 28, 2019

(54) PORTABLE PHOTOVOLTAIC MODULE V-I TESTER AND PHOTOVOLTAIC MODULE TEST SYSTEM

(71) Applicant: SHANDONG CHEN YU RARE MSTAR TECHNOLOGY LTD, Shandong (CN)

(72) Inventors: Jie LI, Jining (CN); You YU, Jining (CN); Shiwei LIU, Jining (CN); Jian SHI, Jining (CN)

(73) Assignee: SHANDONG CHEN YU RARE MSTAR TECHNOLOGY LTD, Shandong (CN)

(21) Appl. No.: 16/525,602

(22) Filed: Jul. 30, 2019

Related U.S. Application Data
(63) Continuation of application No. PCT/CN2018/000067, filed on Feb. 7, 2018.

(30) Foreign Application Priority Data
Feb. 22, 2017 (CN) 201710096569.6

(51) Int. Cl. H02S 50/15

(52) U.S. Cl. CPC H02S 50/15

(57) ABSTRACT

A portable photovoltaic module V-I tester and a photovoltaic module test system comprises a host comprising a power unit and a control unit; an AD acquisition module is configured to measure values of voltage and current of a photovoltaic module, and transmit measured voltage and current values to a single chip microcomputer; the single chip microcomputer screens and processes received data information, analyzing, collecting statistics on and storing acquired photovoltaic module data, after comparing the acquired photovoltaic module data with a corresponding threshold, and outputs to a display module for displaying. The portable photovoltaic module V-I tester may carry out voltage division calculation on an input voltage of a high-power photovoltaic module with a large measuring range, which may be applied in a safe measuring range, and improve measuring precision. The host is provided with an infrared temperature sensor.

### CROSS-REFERENCE TO RELATED APPLICATIONS

This application is a continuation of International PCT application serial no. PCT/CN2018/000067, filed on Feb. 7, 2018, which claims the priority benefit of China application no. 201710096569.6, filed on Feb. 22, 2017. The entirety of each of the above-mentioned patent applications is hereby incorporated by reference herein and made a part of this specification.

### TECHNICAL FIELD

The present disclosure relates to the field of photovoltaic module, more particularly, to a portable photovoltaic module V-I tester and a test system.

### BACKGROUND

Energy is an important material basis for the existence and development of human society. With the development of human industrial civilization, the demand for electric power increases correspondingly. At present, fossil fuels such as petroleum, coal and natural gas and the like account for the majority of the world's energy. Among them, fossil energy is a non-renewable resource, which will eventually be exhausted after a large amount of consumption. In addition, during the production and consumption process, a large number of pollutants will be discharged, damaging the global ecological environment. With extreme exploitation and utilization of fossil energy, the problem of energy crisis is increasingly serious. Therefore, the primary task of the current energy development strategy is to adjust the existing energy structure and seek a new renewable and clean energy to replace the increasingly scarce mineral energy.

At present, solar energy is a form of power utilization. A photovoltaic module is a power generation device that will generate direct current when exposed to sunlight. The photovoltaic module is composed of nearly all solid photovoltaic battery made of semiconductor materials. For the field test of photovoltaic module output characteristics, a traditional photovoltaic volt-ampere characteristic test method is the field test method of variable power resistor. Using the variable power resistor as the output load of the photovoltaic module, the resistor value of the resistor is continuously adjusted manually, and the current and voltage of the circuit are continuously detected through the ammeter and voltmeter in the process. This test method is complicated for controlling with limited sampling points and long sampling time. In consideration of the changes of the external environment in the acquisition process, errors of the sampling points are relatively severe.

### SUMMARY

In order to overcome the forgoing problems, a purpose of the disclosure is to provide a portable photovoltaic module V-I tester, the portable photovoltaic module V-I tester comprises a host including a power unit and a control unit; the control unit comprises a single chip microcomputer, an AD acquisition module and a display module; the power unit comprises a power supply module, a charging module and a power supply battery for supplying power to an internal element of the tester.

The power supply module and the charging module are respectively electrically connected to the power supply battery; the power supply module is connected to a power supply end of the power supply battery; the power supply module is configured to transform and stabilize a power supply voltage of the power supply battery; the charging module is connected to and a charging end of the power supply battery; the charging module is configured to stabilize a charging voltage of the power supply battery.

The display module and the AD acquisition module are respectively connected to the single chip microcomputer; the AD acquisition module is configured to measure a voltage and a current of the photovoltaic module and transmit the voltage and the current to the single chip microcomputer.

The single chip microcomputer receives data information collected by the AD acquisition module; screens and processes received data information; analyzes, collects statistics on and stores collected photovoltaic module data; compares the collected photovoltaic module data with a corresponding threshold; and outputs to the display module for displaying.

Preferably, the portable photovoltaic module V-I tester further comprises a slave.

The host further comprises a host data communication module.

The slave comprises a slave data communication module, a slave processor and a slave storage module.

The slave data communication module is communicatively connected to the host data communication module for data exchange between the host and the slave.

The slave storage module is configured to store standard parameters of solar photovoltaic module including light intensity, temperature data, current data and voltage data.

The slave processor is configured to transmit the standard parameters of the solar photovoltaic module to the host for analyzing and collecting statistics on the collected photovoltaic module data via a communicative connection between the slave data communication module and the host data communication module.

Preferably, the control unit comprises a test circuit.

The test circuit includes a resistor R20, a resistor R21, a resistor R22, a resistor R23, a resistor R24, a first switch end, a second switch end, a third switch end, a fourth switch end, a fifth switch end, a first access end, a second access end, a third access end, a fourth access end, a current transformer, a capacitor C11, a normally open relay K1, a normally open relay K2, a normally open relay K3, a first output end and a second output end.

Two ends of the normally open relay K1 are respectively connected to the first switch end and the second switch end; the third switch end and the fifth switch end are respectively connected to two ends of the normally open relay K2; the fourth switch end and the fifth switch end are respectively connected to two ends of the normally open relay K3.

The first access end, the first output end, the first switch end and a first end of the resistor R20 are connected together; a second end of the resistor R20, a second access end, a first end of the resistor R21 are connected together; a second end of the resistor R21, the second output end, a first pin of the current transformer are connected together; the second switch end, a first end of the capacitor C11, a first end of the resistor R22 and a first end of the resistor R23 are connected together; a second end of the capacitor C11, a second end of the resistor R23, the fourth access end, a second pin of the current transformer are connected together; a second end of the resistor R22 is connected to a third access end; a second end of the resistor R23 is connected to the fourth switch end; the fifth switch end, the third access end, a first end of the resistor R24 are connected together; a third pin of the current transformer is in power connection; a fourth pin of the current transformer is connected to the AD acquisition module; the fifth pin of the current transformer is grounded.

Preferably, the control unit further comprises a relay control unit.

The relay control unit, connected to the single chip microcomputer, comprises a first relay control circuit, a second relay control circuit and a third relay control circuit.

The first relay control circuit comprises a resistor R1, a resistor R2, a diode D1, a transistor Q1, a relay K1 control coil and a normally open relay K1.

An input end of the first relay control circuit is connected to the single chip microcomputer for receiving input control signal of the single chip microcomputer; a first end of the resistor R1 is connected to the input end of the first relay control circuit; a second end of the resistor R1 is connected to a first end of the resistor R2 and a base of the transistor Q1 respectively; a second end of the resistor R2 and an emitter of the transistor Q1 are grounded; a collector of the transistor Q1 is connected to a positive electrode of the diode D1 and a first end of the relay K1 control coil respectively; a negative electrode of the diode D1 and a second end of the relay K1 control coil are both in power connection; two ends of the normally open relay K1 are respectively connected to the first access end and the second access end.

The second relay control unit comprises a resistor R3, a resistor R4, a diode D2, a transistor Q2, a relay K2 control coil and a normally open relay K2.

An input end of the second relay control circuit is connected to the single chip microcomputer for receiving input control signal of the single chip microcomputer; a first end of the resistor R3 is connected to the input end of the first relay control circuit; a second end of the resistor R3 is connected to a first end of the resistor R4 and a base of the transistor Q2 respectively; a second end of the resistor R4 and an emitter of the transistor Q2 are grounded; a collector of the transistor Q2 is connected to a positive electrode of the diode D2 and a first end of the relay K2 control coil respectively; a negative electrode of the diode D2 and a second end of the relay K2 control coil are respectively in power connection; two ends of the normally open relay K2 are respectively connected to the third access end and the fifth access end.

The third relay control circuit comprises a resistor R5, a resistor R6, a diode D3, a transistor Q3, a relay K3 control coil and a normally open relay K3.

An input end of the third relay control circuit is connected to the single chip microcomputer for receiving input control signal of the single chip microcomputer; a first end of the resistor R5 is connected to the input end of the first relay control circuit; a second end of the resistor R5 is connected to a first end of the resistor R6 and a base of the transistor Q3 respectively; a second end of the resistor R5 and an emitter of the transistor Q3 are grounded; a collector of the transistor Q3 is connected to a positive electrode of the diode D3 and a first end of the relay K3 control coil respectively; a negative electrode of the diode D3 and a second end of the relay K3 control coil are respectively in power connection; two ends of the normally open relay K3 are respectively connected to the fourth access end and the fifth access end.

Preferably, the power supply module comprises a booster circuit and a step-down circuit.

The booster circuit comprises a booster chip U11, a resistor RP1, a resistor RP2, a resistor RP3, a resistor RP4, a capacitor CP1, a capacitor CP2, a capacitor CP3, a capacitor CP4, a capacitor CP5, a diode DP1, a diode DP2, an inductance LP1, an inductance LP2.

An input end of the booster circuit is accessed to the power supply battery; a first end of capacitor CP1, a first end of the inductance LP1, a fifth pin of the booster chip U11 and an input end of the booster circuit are connected together; a second end of the capacitor CP1 is grounded; a first end of the capacitor CP5 is connected to a second end of the capacitor CP1; a second end of the capacitor CP5 is grounded; a second end of the inductance LP1, a fourth pin of the booster chip U11, a positive electrode of the diode CP1 are connected together; a negative electrode of the diode DP1, a first end of the capacitor CP2, a first end of the capacitor CP3, a second end of the resistor RP4, a positive electrode of the diode DP2 are connected together; a second end of the capacitor CP2 is grounded; a second end of the capacitor CP3 is grounded; a negative electrode of the diode DP2 is connected to an output end of the booster circuit through the inductance LP2; a first pin of the booster circuit U11 is grounded through the resistor RP1 and the capacitor CP4; a third pin of the booster chip U11 is grounded; a second pin of the booster chip U11, a second end of the resistor RP2 and a first end of the resistor RP3 are connected together; a first end of the resistor RP2 is grounded; a second end of the resistor RP3 is connected to a first end of the resistor RP4.

The step-down circuit comprises a step-down chip U12, a capacitor CJ1, a capacitor CJ2, a capacitor CJ3, a diode DJ2, an inductance LJ1, a resistor RJ1, and a resistor RJ2.

An input end of the step-down circuit is accessed to a power supply battery; a first pin of the step-down chip U12 and a first end of the capacitor CJ1 is connected to an input end of the step-down circuit; a second end of the capacitor CJ1, a fifth pin, a third pin and a sixth pin of the step-down chip U12, a positive electrode of the diode DJ1, a second end of the capacitor CJ2, a second end of the resistor RJ2, a second end of the capacitor CJ3 are all grounded; a second pin of the step-down chip U12 is connected to a negative electrode of the diode DJ1 and a first end of the inductance LJ1; a fourth pin of the step-down chip U12 is connected to a second end of the resistor RJ1 and a first end of the resistor RJ2 respectively; a second end of the inductance LJ1, a first end of the capacitor CJ2, a first end of the resistor RJ1, a first end of the capacitor CJ3, a positive electrode of the diode DJ2 are connected together; a negative electrode of the diode DJ2 is connected to an output end of the step-down circuit.

Preferably, the power supply module comprises a voltage stabilizing circuit and a voltage transforming circuit.

The voltage stabilizing circuit comprises a resistor RU1, a resistor RU2, a resistor RU3, a resistor RU4, a resistor RU5, a capacitor CU1, a diode DU1, a diode DU2, a diode DU3, a diode DU4, a photoelectric chip U13, a field-effect tube QU.

A positive electrode of the diode DU1 is connected to a 5V power supply; the diode DU2 is in power connection; a negative electrode of the diode DU1 and a negative electrode of the diode DU2 are respectively connected to a first end of the resistor RU5; a second end of the resistor RU5 is connected to a first end of the capacitor CU1 and a first pin of the photoelectric chip U13 respectively; a second end of the capacitor CU1 and a second pin of the photoelectric chip U13 are grounded; a fourth pin of the photoelectric U13 is connected to a 12V power supply; a third pin of the photoelectric chip U13 is connected to a first end of the resistor RU1; a second end of the resistor RU1 is connected to a first end of the resistor RU2 and a first end of the field-effect tube QU respectively; a second end of the resistor RU2 is grounded; a second end of the filed-effect tube QU is connected to the 12V power supply and a first end of the resistor RU3 respectively; a third end of the field-effect tube QU is connected to a positive electrode of the diode DU3; a negative electrode of the diode DU3 and a negative electrode of the diode DU4 are respectively connected to an output end of the voltage stabilizing circuit; a positive electrode of the diode DU4 is connected the 5V power supply; a second end of the resistor RU3 is grounded through the resistor RU4; two ends of the resistor RU4 are provided with a connecting end of the acquisition module.

The voltage transforming circuit comprises a voltage transforming chip U15, a capacitor CW1, a capacitor CW2, a capacitor CW3, a capacitor CW4 and an inductance LW.

A third pin of the voltage transforming chip U15, a first end of the capacitor CW1, a first end of the capacitor CW2 are respectively accessed to an input end of the voltage transforming circuit; a fourth pin of the voltage transforming chip U15 is connected to a 3.3V power supply; a second pin of the voltage transforming chip U15 is connected to a first end of the capacitor CW2, a first end of the capacitor CW4 and a first end of the inductance LW respectively; a second end of the capacitor CW1, a second end of the capacitor CW2, a first pin of the voltage transforming chip U15, a second end of the capacitor CW3, a second end of the capacitor CW4 are grounded; a second end of the inductance LW is connected to an output end of the voltage transforming circuit.

Preferably, the charging module comprises a charging voltage transforming circuit.

The charging voltage transforming circuit comprises a resistor RB1, a resistor RB2, a resistor RB3, a resistor RB4, a resistor RB5, a resistor RB6, a capacitance CB1, a capacitance CB2, a capacitance CB3, a capacitance CB4, an inductance LB1, an inductance LB2, an inductance LB3, an inductance LB4, a charging voltage transforming chip U14, a diode DB1, a diode DB2, a diode DB3, a first charging access end J1 and a second charging access end J2.

A second pin of the first charging access end J1 is grounded; a first pin of the first charging access end J1 is connected to a first end of the inductance LB1; a second end of the inductance LB1 a second end of the resistor RB2, a first end of the capacitor CB1, a first end of the resistor LB2, a fifth pin of the charging voltage transforming chip U14 are connected together; a first end of the resistor RB2 is grounded through the resistor RB1; two ends of the resistor RB1 is provided with a connecting end of the AD acquisition module; a second end of the inductance LB2 is grounded; a fourth pin of the charging voltage transforming chip U14 is connected to a positive electrode of the diode DB3; a negative electrode of the diode DB3, a first end of the capacitor CB3, a first end of the capacitor CB4, a second end of resistor RB6 and a positive electrode of the diode DB1 are connected together; a second end of the capacitor CB3 and a second end of the capacitor CB2 are respectively grounded; a third pin of the charging voltage transforming chip U14 is grounded; a first pin of the charging voltage transforming chip U14 is grounded through the resistor RB3 and the capacitor CB2; a second pin of the charging voltage transforming chip U14 is connected to a second end of the resistor RB4 and a first end of the resistor RB5; a first end of the resistor RB4 is grounded; a second end of the resistor RB5 is connected to a first end of the resistor RB6; a negative electrode of the diode DB1 is connected to a first end of inductance LB3; a second end of the inductance LB3 is connected to a positive electrode of the diode DB2 through the inductance LB4; a negative electrode of the diode DB2 is accessed to a second pin of the second charging access end J2; a first pin of the second charging access end J2 is grounded.

Preferably, the charging module further comprises a charging protection circuit.

The charging protection circuit comprises a connecting terminal U21, a voltage stabilizing chip U22, a voltage stabilizing chip U23, a charge-discharge protection chip U24, a charging protection resistor R1, a charging protection resistor R2, a charging protection resistor R3, a charging protection resistor R4, a charging protection resistor R5, a charging protection resistor R6, a charging protection resistor R7, a charging protection resistor R8, a charging protection resistor R9, a charging protection resistor R10, a charging protection resistor R11, a charging protection capacitor C1, a charging protection capacitor C3, a charging protection capacitor C4, a charging protection capacitor C5 and a charging protection capacitor C6.

A first pin of the connecting terminal U21 is connected to an input power of the charging protection circuit, a first pin, a second pin and third pin of the voltage stabilizing chip U23, a first end of the charging protection resistor R5 and a first end of the charging protection resistor R6 respectively; a second pin and a fourth pin of the connecting terminal U21, a first end of the charging protection resistor R9 and a first end of the charging protection resistor R10 are respectively grounded; a third pin of the connecting terminal U21, a first pin, a second pin, a third pin of the voltage stabilizing chip U22 and a first end of the charging protection capacitor C6 are connected together; a fifth pin of connecting terminal U21 is connected to a first end of the charging protection resistor R2; a sixth pin of the connecting terminal U21 is connected to a first end of the charging protection capacitor C3 and a first end of the charging protection resistor R3 respectively; a fourth pin of the voltage stabilizing chip U22 is connected to a first end of the charging protection resistor R7; a fourth pin of the voltage stabilizing chip U23 is connected to a second end of the charging protection resistor R5 and a first pin of the charge-discharge protection chip U24 respectively; a second end of the charging protection resistor R6 is connected to a second pin of the charge-discharge protection chip U24; a third pin of the charge-discharge protection chip U24 is connected to a second end of the charging protection resistor R7; a fourth pin of the charge-discharge protection chip U24 is connected to a second end of the charging protection resistor R9; a fifth pin of the charge-discharge protection chip U24 is connected to a second end of the charge-discharge protection capacitor C4; a first end of capacitor C4, a second end of charging protection resistor R10, a first end of capacitor C5, a second end of the charging protection resistor R11, a second end of charging protection resistor R4, and 12th pin of the charge-discharge protection chip U24 are connected together; a sixth pin of charge-discharge protection chip U24 is connected to a second end of the charging protection capacitor C5; a seventh pin of the charge-discharge protection chip U24 is connected to a second end of the charge-discharge protection capacitor C6; a 10th pin of the charge-discharge protection chip U24 is connected to a first end of the charging protection resistor R11; a 11th pin of the charge-discharge protection chip U24 is connected to a first end of the charging protection resistor R4; a 13th pin of the charge-discharge protection chip U24 is connected to a second end of the charging protection resistor R3; a second end of the charging protection resistor R3, and the 14th pin of the charge-discharge protection chip U24 are connected to a second end of the charging protection resistor R2; a 15th pin of the charge-discharge protection chip U24 is connected to a first end of the charging protection resistor R1 and a first end of the charging protection capacitor C1 respectively; a 16th pin of U24 is connected to a second end of the charging protection resistor R1, a second end of the charging protection capacitor C1 and a second end of charging protection capacitor C3 respectively.

Preferably, the host further comprises a host six-axis gyroscope, a sun angle calculation module.

The sun angle calculation module is configured to calculate values of a sun altitude angle and a sun azimuth angle through a sun position algorithm after entering a sun trajectory tracking program; and based on the values of the sun altitude angle and the sun azimuth angle, an angle to be adjusted by the host six-axis gyroscope is calculated.

The host six-axis gyroscope is configured to adjust an angle of sunlight obtained by the host.

The slave comprises a slave six-axis gyroscope.

The slave six-axis gyroscope is configured to adjust an angle of sunlight obtained by the slave, and transmit the angle of sunlight obtained by the slave to the host for revising the angle of sunlight obtained by the host.

Preferably, the host further comprises an infrared temperature sensor, a USB charging interface, a USB power supply interface and a data storage module.

The infrared temperature sensor is connected to the single chip microcomputer; the infrared temperature sensor is configured to sense a light intensity and transmit the light intensity, which is sensed, to the single chip microcomputer.

The USB charging interface is connected to the power supply battery through the charging module; the USB charging interface is configured to charge the power supply battery through a connection with an external power supply.

The USB power supply interface is connected to the power supply battery through the power supply module; the USB power supply interface is configured to enable the power supply battery to supply power to other devices.

The data storage module is configured to store the data information collected by the AD acquisition module and the data information of the photovoltaic module data analyzed and statistically collected by the single chip microcomputer.

A photovoltaic module test system comprises a photovoltaic module V-I tester and a plurality of mobile terminals connected to the photovoltaic module V-I tester.

The photovoltaic module V-I tester comprises a data sharing platform;

The mobile terminals comprise clients.

The data sharing platform is configured to release the data information stored by the photovoltaic module VI tester for the clients of the mobile terminals to connected to; enable the mobile terminals to obtain data information stored by the data sharing platform, and provide knowledge exchange of testing personnel, and test a process case to realize knowledge sharing and management through a plurality of stored test process logs.

As may be seen from above technical solutions, beneficial effects of the present disclosure include:

The portable photovoltaic module V-I tester may carry out voltage division calculation on an input voltage of a high-power photovoltaic module with a large measuring range, which may be applied in a safe measuring range, and improve measuring precision. The circuit principle design is concise, and the elements are reasonably laid out, such that the size of the device may be reduced significantly. The portable photovoltaic module V-I tester is portable. The display module adopts a 3.5-inch LCD screen and a membrane key panel, which is convenient for using and reading clearly; the host is provided with an infrared temperature sensor which may help the host in temperature correction, thus improving measuring precision.

### BRIEF DESCRIPTION OF THE ACCOMPANYING DRAWINGS

In order to illustrate the technical solutions of the present disclosure to be more clearly, the following drawings required in the description will be introduced briefly. Apparently, the following drawings merely represent some embodiments of the present disclosure. For those skilled in the art, alternative drawings may be derived from the following drawings without creative efforts.

FIG. 1 is an overall schematic view of a photovoltaic module V-I tester;

FIG. 2 is a VI curve chart;

FIG. 3 is a circuit diagram of a test circuit;

FIG. 4 is a circuit diagram of a first relay control circuit;

FIG. 5 is a circuit diagram of a second relay control circuit;

FIG. 6 is a circuit diagram of a third relay control circuit;

FIG. 7 is a circuit diagram of a booster circuit;

FIG. 8 is a circuit diagram of a step-down circuit;

FIG. 9 is a circuit diagram of a voltage stabilizing circuit;

FIG. 10 is a circuit diagram of a voltage transforming circuit;

FIG. 11 is a circuit diagram of a charging voltage transforming circuit; and

FIG. 12 is a circuit diagram of a charging protection circuit.

### DETAILED DESCRIPTION OF ILLUSTRATED EMBODIMENTS

In order to enable the purpose, features and advantages of the present disclosure to be more obvious and easier to be understood, specific embodiments and accompanying drawings will be described below to describe the technical solutions to be protected by the present disclosure. Obviously, the embodiments described below are only some, but no exclusive of the embodiments of the present disclosure. Based on the embodiments described in this present disclosure, all other embodiments obtained by those skilled in the field without creative efforts should belong to the scope of the present disclosure.

An embodiment provides a portable photovoltaic module V-I tester. Referring to FIG. 1, the portable photovoltaic module V-I tester comprises a host including a power unit and a control unit; the control unit comprises a single chip microcomputer 3, an AD acquisition module 2 and a display module 4; the power unit comprises a power supply module, a charging module and a power supply battery for supplying power to an internal element of the tester.

The power supply module and the charging module are respectively electrically connected to the power supply battery; the power supply module is connected to a power supply end of the power supply battery; the power supply module is configured to transform and stabilize a power supply voltage of the power supply battery; the charging module is connected to a charging end of the power supply battery; the charging module is configured to stabilize and transform a charging voltage of the power supply battery.

The display module 4 and the AD acquisition module 2 are respectively connected to the single chip microcomputer 3; the AD acquisition module 2 is configured to measure a voltage and a current of the photovoltaic module and transmit the voltage and the current to the single chip microcomputer 3; the single chip microcomputer 3 is used to receive data information collected by the AD acquisition module 2; screening and processing received data information, analyzing, collecting statistics on and storing collected photovoltaic module 1 data, after comparing the collected photovoltaic module 1 data with a corresponding threshold, outputting to the display module 4 for displaying.

In an embodiment, the portable photovoltaic module V-I tester further comprises a slave 11.

The host further comprises a host data communication module. The slave 11 comprises a slave data communication module 8, a slave processor 9 and a slave storage module 10.

The slave data communication module 8 is communicatively connected to the host data communication module 7 for data exchange between the host and the slave 11. The slave storage module 10 is configured to store standard parameters of the photovoltaic module 1 including light intensity, temperature data, current data and voltage data.

The slave processor 9 is configured to transmit the standard parameters of the photovoltaic module 1 to the host to analyze and collect statistics on the collected photovoltaic module data via a communicative connection between the slave data communication module and the host data communication module. Preferably, the host and the slave communicate and exchange data with each other via Bluetooth or Wi-Fi.

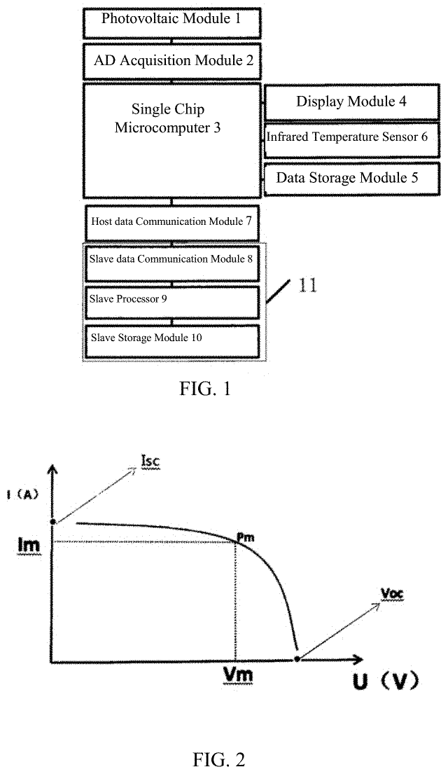

The parameters of the collected photovoltaic module 1 data, which is analyzed, on which statistics is collected and stored by the photovoltaic module V-I tester, include a maximum power Pm, measured in W (watt), wherein P=UI. In other words, power is equal to voltage times current. The maximum power may be calculated by measuring a real time (AD fast acquisition) V-I curve, as shown in FIG. 2. The maximum power is not necessarily equal to a maximum voltage times a maximum current. A maximum working voltage, Vm, refers to a voltage under the maximum power, which is measure by V (Volt) with a precision within 000.000V. A maximum working current, Im, refers to a current under the maximum power, which is measure by A (ampere) with a precision within 000.000 A. An open-circuit voltage Voc refers to a maximum voltage at the end of the V-I curve with a precision within 000.000V. A short-circuit voltage Isc refers to a maximum current at the beginning of the V-I curve with a precision within 000.000 A. A fill factor equals to Pm/Voc*Isc, measured by % with a precision within 00.0%. A module efficiency equals to Pm/area*incident light of P, measured by % with a precision within 00.0%.

In an embodiment, the control unit comprises a test circuit. Referring to FIG. 3, the test circuit includes a resistor R20, a resistor R21, a resistor R22, a resistor R23, a resistor R24, a first switch end OUT1, a second switch end OUT2, a third switch end OUT3, a fourth switch end OUT4, a fifth switch end OUT5, a first access end AD1, a second access end AD2, a third access end AD3, a fourth access end AD4, a current transformer U31, a capacitor C11, a normally open relay K1, a normally open relay K2, a normally open relay K3, a first output end OUT+ and a second output end OUT−.

Two ends of the normally open relay K1 are respectively connected to the first switch end OUT1 and the second switch end OUT2; the third switch end OUT3 and the fifth switch end OUT5 are respectively connected to two ends of the normally open relay K2; the fourth switch end OUT4 and the fifth switch end OUT5 are respectively connected to two ends of the normally open relay K3.

The first access end AD1, the first output end OUT+, the first switch end OUT1 and a first end of the resistor R20 are connected together; a second end of the resistor R20, a second access end AD2, a first end of the resistor R21 are connected together; a second end of the resistor R21, the second output end, a first pin of the current transformer are connected together; the second switch end, a first end of the capacitor C11, a first end of the resistor R22 and a first end of the resistor R23 are connected together; a second end of the capacitor C11, a second end of the resistor R23, the fourth access end, a second pin of the current transformer are connected together; a second end of the resistor R22 is connected to a third access end; a second end of the resistor R23 is connected to the fourth switch end; the fifth switch end, the third access end, a first end of the resistor R24 are connected together; a third pin of the current transformer is in power connection; a fourth pin of the current transformer is connected to the AD acquisition module; the fifth pin of the current transformer is grounded.

While measuring, a positive electrode and a negative electrode of a photovoltaic battery panel are respectively connected to the OUT+ and the OUT−. The voltage of the measured battery panel and the positive and the negative electrode are not known prior to measuring, and the positive and the negative electrode are likely to be reversely connected; the positive and the negative electrode may be connected reversely. At first, a voltage accessed in may be divided by two series-connected divider resistors R20 and R21; two acquisition ends of the AD acquisition module are respectively connected to two ends of the R20, and the acquired voltage of the R20 is IV, such that the voltage between the OUT+ and the OUT− is determined to be 50. Then the single chip microcomputer controls the relay switch between the OUT1 and the OUT2 to be switched on, such that a gross range of the voltage is calculated, and a corresponding switch may be selected and turned on, such as the third switch end OUT3 and the fifth switch end OUT5, or the fourth switch end OUT4 and the fifth switch end OUT5.

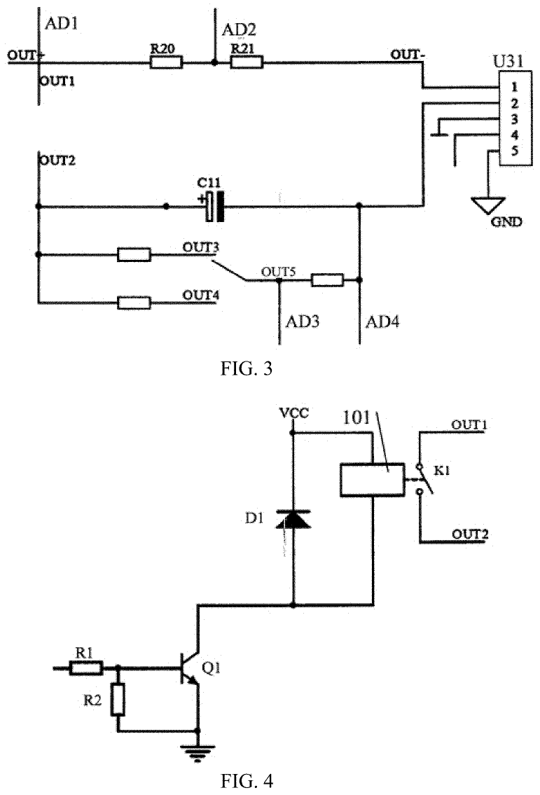

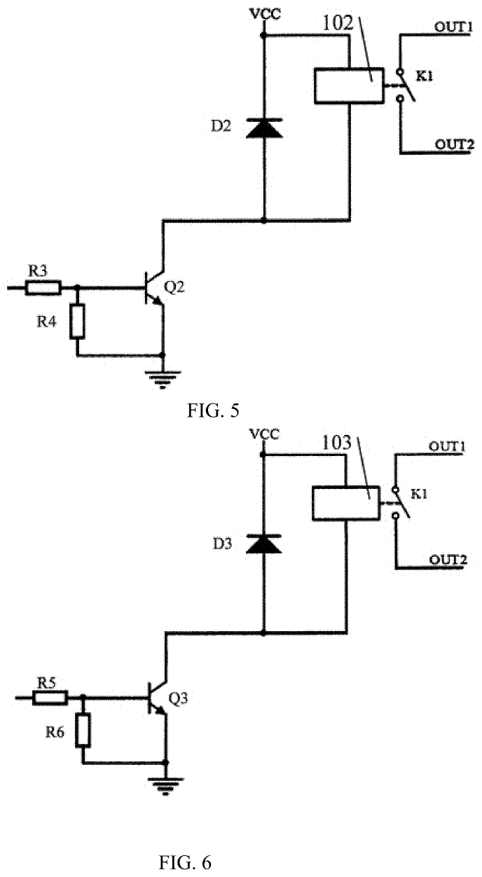

In an embodiment, the control unit further comprises a relay control unit. The relay control unit, connected to the single chip microcomputer, comprises a first relay control circuit, a second relay control circuit and a third relay control circuit, as shown in FIGS. 4-6.

The first relay control circuit comprises a resistor R1, a resistor R2, a diode D1, a transistor Q1, a relay K1 control coil 101 and a normally open relay K1. An input end of the first relay control circuit is connected to the single chip microcomputer for receiving input control signal of the single chip microcomputer; a first end of the resistor R1 is connected to the input end of the first relay control circuit; a second end of the resistor R1 is connected to a first end of the resistor R2 and a base of the transistor Q1 respectively; a second end of the resistor R2 and an emitter of the transistor Q1 are grounded; a collector of the transistor Q1 is connected to a positive electrode of the diode D1 and a first end of the relay K1 control coil respectively; a negative electrode of the diode D1 and a second end of the relay K1 control coil are both in power connection; two ends of the normally open relay K1 are respectively connected to the first access end and the second access end.

The second relay control unit comprises a resistor R3, a resistor R4, a diode D2, a transistor Q2, a relay K2 control coil 102 and a normally open relay K2. An input end of the second relay control circuit is connected to the single chip microcomputer for receiving input control signal of the single chip microcomputer; a first end of the resistor R3 is connected to the input end of the first relay control circuit; a second end of the resistor R3 is connected to a first end of the resistor R4 and a base of the transistor Q2 respectively; a second end of the resistor R4 and an emitter of the transistor Q2 are grounded; a collector of the transistor Q2 is connected to a positive electrode of the diode D2 and a first end of the relay K2 control coil respectively; a negative electrode of the diode D2 and a second end of the relay K2 control coil are respectively in power connection; two ends of the normally open relay K2 are respectively connected to the third access end and the fifth access end.

The third relay control circuit comprises a resistor R5, a resistor R6, a diode D3, a transistor Q3, a relay K3 control coil 103 and a normally open relay K3. An input end of the third relay control circuit is connected to the single chip microcomputer for receiving input control signal of the single chip microcomputer; a first end of the resistor R5 is connected to the input end of the first relay control circuit; a second end of the resistor R5 is connected to a first end of the resistor R6 and a base of the transistor Q3 respectively; a second end of the resistor R5 and an emitter of the transistor Q3 are grounded; a collector of the transistor Q3 is connected to a positive electrode of the diode D3 and a first end of the relay K3 control coil respectively; a negative electrode of the diode D3 and a second end of the relay K3 control coil are respectively in power connection; two ends of the normally open relay K3 are respectively connected to the fourth access end and the fifth access end.

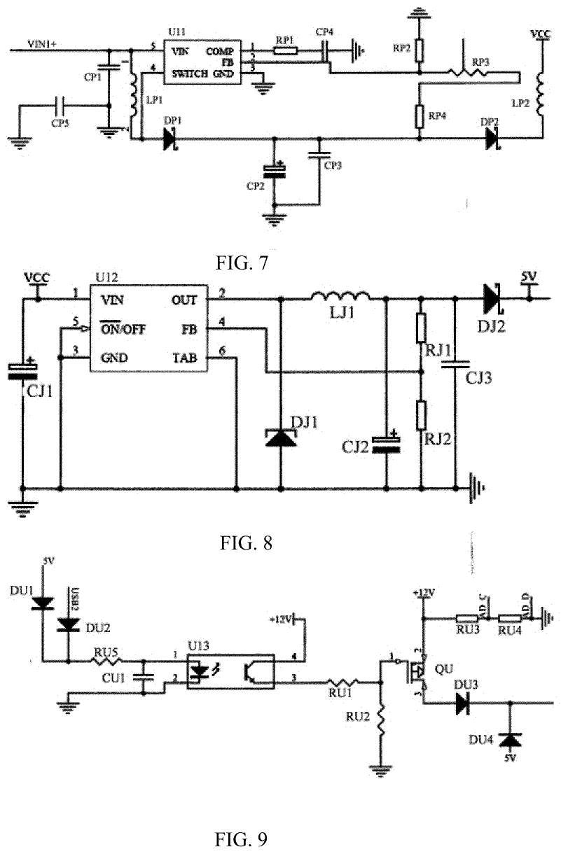

In an embodiment, the power supply module comprises a booster circuit and a step-down circuit. As shown in FIGS. 7 and 8, the booster circuit comprises a booster chip U11, a resistor RP1, a resistor RP2, a resistor RP3, a resistor RP4, a capacitor CP1, a capacitor CP2, a capacitor CP3, a capacitor CP4, a capacitor CP5, a diode DP1, a diode DP2, an inductance LP1, an inductance LP2.

An input end of the booster circuit is accessed to the power supply battery; a first end of capacitor CP1, a first end of the inductance LP1, a fifth pin of the booster chip U11 and an input end of the booster circuit are connected together; a second end of the capacitor CP1 is grounded; a first end of the capacitor CP5 is connected to a second end of the capacitor CP1; a second end of the capacitor CP5 is grounded; a second end of the inductance LP1, a fourth pin of the booster chip U11, a positive electrode of the diode CP1 are connected together; a negative electrode of the diode DP1, a first end of the capacitor CP2, a first end of the capacitor CP3, a second end of the resistor RP4, a positive electrode of the diode DP2 are connected together; a second end of the capacitor CP2 is grounded; a second end of the capacitor CP3 is grounded; a negative electrode of the diode DP2 is connected to an output end of the booster circuit through the inductance LP2; a first pin of the booster circuit U11 is grounded through the resistor RP1 and the capacitor CP4; a third pin of the booster chip U11 is grounded; a second pin of the booster chip U11, a second end of the resistor RP2 and a first end of the resistor RP3 are connected together; a first end of the resistor RP2 is grounded; a second end of the resistor RP3 is connected to a first end of the resistor RP4.

The step-down circuit comprises a step-down chip U12, a capacitor CJ1, a capacitor CJ2, a capacitor CJ3, a diode DJ2, an inductance LJ1, a resistor RJ1, and a resistor RJ2.

An input end of the step-down circuit is accessed to a power supply battery; a first pin of the step-down chip U12 and a first end of the capacitor CJ1 is connected to an input end of the step-down circuit; a second end of the capacitor CJ1, a fifth pin, a third pin and a sixth pin of the step-down chip U12, a positive electrode of the diode DJ1, a second end of the capacitor CJ2, a second end of the resistor RJ2, a second end of the capacitor CJ3 are all grounded; a second pin of the step-down chip U12 is connected to a negative electrode of the diode DJ1 and a first end of the inductance LJ1; a fourth pin of the step-down chip U12 is connected to a second end of the resistor RJ1 and a first end of the resistor RJ2 respectively; a second end of the inductance LJ1, a first end of the capacitor CJ2, a first end of the resistor RJ1, a first end of the capacitor CJ3, a positive electrode of the diode DJ2 are connected together; a negative electrode of the diode DJ2 is connected to an output end of the step-down circuit.

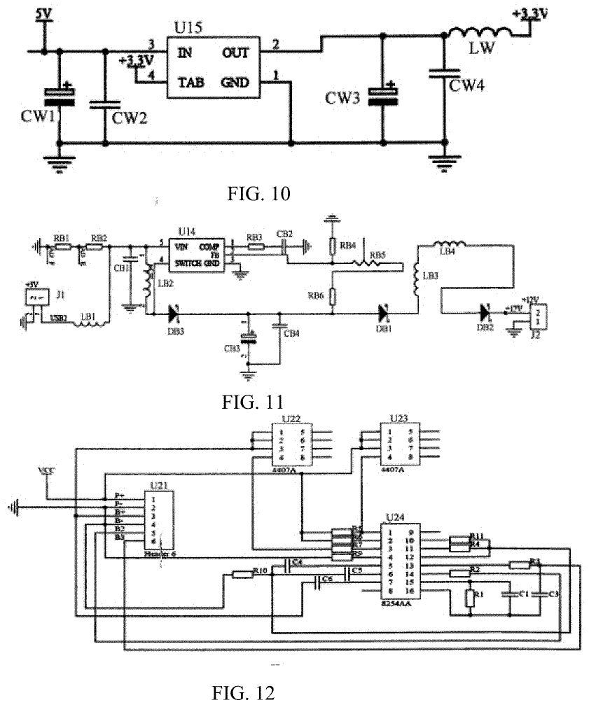

In an embodiment, the power supply module further comprises a voltage stabilizing circuit and a voltage transforming circuit. As shown in FIGS. 9 and 10, the voltage stabilizing circuit comprises a resistor RU1, a resistor RU2, a resistor RU3, a resistor RU4, a resistor RU5, a capacitor CU1, a diode DU1, a diode DU2, a diode DU3, a diode DU4, a photoelectric chip U13, a field-effect tube QU. A positive electrode of the diode DU1 is connected to a 5V power supply; the diode DU2 is connected to the power supply; a negative electrode of the diode DU1 and a negative electrode of the diode DU2 are respectively connected to a first end of the resistor RU5; a second end of the resistor RU5 is connected to a first end of the capacitor CU1 and a first pin of the photoelectric chip U13 respectively; a second end of the capacitor CU1 and a second pin of the photoelectric chip U13 are grounded; a fourth pin of the photoelectric U13 is connected to a 12V power supply; a third pin of the photoelectric chip U13 is connected to a first end of the resistor RU1; a second end of the resistor RU1 is connected to a first end of the resistor RU2 and a first end of the field-effect tube QU respectively; a second end of the resistor RU2 is grounded; a second end of the field-effect tube QU is connected to the 12V power supply and a first end of the resistor RU3 respectively; a third end of the field-effect tube QU is connected to a positive electrode of the diode DU3; a negative electrode of the diode DU3 and a negative electrode of the diode DU4 are respectively connected to an output end of the voltage stabilizing circuit; a positive electrode of the diode DU4 is connected to the 5V power supply; a second end of the resistor RU3 is grounded through the resistor RU4; two ends of the resistor RU4 are provided with a connecting end of the acquisition module.

The voltage transforming circuit comprises a voltage transforming chip U15, a capacitor CW1, a capacitor CW2, a capacitor CW3, a capacitor CW4 and an inductance LW. A third pin of the voltage transforming chip U15, a first end of the capacitor CW1, a first end of the capacitor CW2 are respectively accessed to an input end of the voltage transforming circuit; a fourth pin of the voltage transforming chip U15 is connected to a 3.3V power supply; a second pin of the voltage transforming chip U15 is connected to a first end of the capacitor CW2, a first end of the capacitor CW4 and a first end of the inductance LW respectively; a second end of the capacitor CW1, a second end of the capacitor CW2, a first pin of the voltage transforming chip U15, a second end of the capacitor CW3, and a second end of the capacitor CW4 are grounded; a second end of the inductance LW is connected to an output end of the voltage transforming circuit.

In an embodiment, the charging module comprises a charging voltage transforming circuit, as shown in FIG. 11.

The charging voltage transforming circuit comprises a resistor RB1, a resistor RB2, a resistor RB3, a resistor RB4, a resistor RB5, a resistor RB6, a capacitance CB1, a capacitance CB2, a capacitance CB3, a capacitance CB4, an inductance LB1, an inductance LB2, an inductance LB3, an inductance LB4, a charging voltage transforming chip U14, a diode DB1, a diode DB2, a diode DB3, a first charging access end J1 and a second charging access end J2. A second pin of the first charging access end J1 is grounded; a first pin of the first charging access end J1 is connected to a first end of the inductance LB1; a second end of the inductance LB1, a second end of the resistor RB2, a first end of the capacitor CB1, a first end of the resistor LB2, and a fifth pin of the charging voltage transforming chip U14 are connected together; a first end of the resistor RB2 is grounded through the resistor RB1; two ends of the resistor RB1 is provided with a connecting end of the AD acquisition module; a second end of the inductance LB2 is grounded; a fourth pin of the charging voltage transforming chip U14 is connected to a positive electrode of the diode DB3; a negative electrode of the diode DB3, a first end of the capacitor CB3, a first end of the capacitor CB4, a second end of resistor RB6 and a positive electrode of the diode DB1 are connected together; a second end of the capacitor CB3 and a second end of the capacitor CB2 are respectively grounded; a third pin of the charging voltage transforming chip U14 is grounded; a first pin of the charging voltage transforming chip U14 is grounded through the resistor RB3 and the capacitor CB2; a second pin of the charging voltage transforming chip U14 is connected to a second end of the resistor RB4 and a first end of the resistor RB5; a first end of the resistor RB4 is grounded; a second end of the resistor RB5 is connected to a first end of the resistor RB6; a negative electrode of the diode DB1 is connected to a first end of inductance LB3; a second end of the inductance LB3 is connected to a positive electrode of the diode DB2 through the inductance LB4; a negative electrode of the diode DB2 is accessed to a second pin of the second charging access end J2; a first pin of the second charging access end J2 is grounded.

In an embodiment, the charging module further comprises a charging protection circuit. As shown in FIG. 12, the charging protection circuit comprises a connecting terminal U21, a voltage stabilizing chip U22, a voltage stabilizing chip U23, a charge-discharge protection chip U24, a charging protection resistor R1, a charging protection resistor R2, a charging protection resistor R3, a charging protection resistor R4, a charging protection resistor R5, a charging protection resistor R6, a charging protection resistor R7, a charging protection resistor R8, a charging protection resistor R9, a charging protection resistor R10, a charging protection resistor R11, a charging protection capacitor C1, a charging protection capacitor C3, a charging protection capacitor C4, a charging protection capacitor C5 and a charging protection capacitor C6.

A first pin of the connecting terminal U21 is connected to an input power of the charging protection circuit, a first pin, a second pin and third pin of the voltage stabilizing chip U23, a first end of the charging protection resistor R5 and a first end of the charging protection resistor R6 respectively; a second pin and a fourth pin of the connecting terminal U21, a first end of the charging protection resistor R9 and a first end of the charging protection resistor R10 are respectively grounded; a third pin of the connecting terminal U21, a first pin, a second pin, a third pin of the voltage stabilizing chip U22 and a first end of the charging protection capacitor C6 are connected together; a fifth pin of connecting terminal U21 is connected to a first end of the charging protection resistor R2; a sixth pin of the connecting terminal U21 is connected to a first end of the charging protection capacitor C3 and a first end of the charging protection resistor R3 respectively; a fourth pin of the voltage stabilizing chip U22 is connected to a first end of the charging protection resistor R7; a fourth pin of the voltage stabilizing chip U23 is connected to a second end of the charging protection resistor R5 and a first pin of the charge-discharge protection chip U24 respectively; a second end of the charging protection resistor R6 is connected to a second pin of the charge-discharge protection chip U24; a third pin of the charge-discharge protection chip U24 is connected to a second end of the charging protection resistor R7; a fourth pin of the charge-discharge protection chip U24 is connected to a second end of the charging protection resistor R9; a fifth pin of the charge-discharge protection chip U24 is connected to a second end of the charge-discharge protection capacitor C4; a first end of capacitor C4, a second end of charging protection resistor R10, a first end of capacitor C5, a second end of the charging protection resistor R11, a second end of charging protection resistor R4, and 12th pin of the charge-discharge protection chip U24 are connected together; a sixth pin of charge-discharge protection chip U24 is connected to a second end of the charging protection capacitor C5; a seventh pin of the charge-discharge protection chip U24 is connected to a second end of the charge-discharge protection capacitor C6; a 10th pin of the charge-discharge protection chip U24 is connected to a first end of the charging protection resistor R11; a 11th pin of the charge-discharge protection chip U24 is connected to a first end of the charging protection resistor R4; a 13th pin of the charge-discharge protection chip U24 is connected to a second end of the charging protection resistor R3; a second end of the charging protection resistor R3, and the 14th pin of the charge-discharge protection chip U24 are connected to a second end of the charging protection resistor R2; a 15th pin of the charge-discharge protection chip U24 is connected to a first end of the charging protection resistor R1 and a first end of the charging protection capacitor C1 respectively; a 16th pin of U24 is connected to a second end of the charging protection resistor R1, a second end of the charging protection capacitor C1 and a second end of charging protection capacitor C3 respectively.

In an embodiment, the host further comprises a host six-axis gyroscope, and a sun angle calculation module.

The sun angle calculation module is configured to calculate values of a sun altitude angle and a sun azimuth angle through a sun position algorithm after entering a sun trajectory tracking program; and based on the values of the sun altitude angle and the sun azimuth angle, an angle to be adjusted by the host six-axis gyroscope is calculated.

The host six-axis gyroscope is configured to adjust an angle of sunlight obtained by the host.

The slave comprises a slave six-axis gyroscope.

The slave six-axis gyroscope is configured to adjust an angle of sunlight obtained by the slave, and transmit the angle of sunlight obtained by the slave to the host for revising the angle of sunlight obtained by the host. The revising method may include acquiring a mean value of the angle of sunlight obtained by the host and the angle of sunlight obtained by the slave. The mean value is determined by the host as the angle of sunlight.

The host six-axis gyroscope and the slave six-axis gyroscope respectively adopt an MPU6050 six-axis gyroscope.

In an embodiment, the host further comprises an infrared temperature sensor 6, a USB charging interface, a USB power supply interface and a data storage module 5.

The infrared temperature sensor 6 is connected to the single chip microcomputer 3; the infrared temperature sensor 6 is configured to sense a light intensity and transmit the light intensity, which is sensed, to the single chip microcomputer 3.

The USB charging interface is connected to the power supply battery through the charging module; the USB charging interface is configured to charge the power supply battery through a connection with an external power supply. The USB power supply interface is connected to the power supply battery through the power supply module; the USB power supply interface is configured to enable the power supply battery to supply power to other devices. The data storage module 5 is configured to store the data information collected by the AD acquisition module 2 and the data information of the photovoltaic module data analyzed and statistically collected by the single chip microcomputer 3.

The present disclosure further provides a photovoltaic module test system including a photovoltaic module V-I tester and a plurality of mobile terminals connected to the photovoltaic module V-I tester. The photovoltaic module V-I tester comprises a data sharing platform. The mobile terminals comprise clients. The data sharing platform is configured to issue the data information stored by the photovoltaic module VI tester to be connected with the clients of the mobile terminals, enabling the mobile terminals to obtain data information stored by the data sharing platform, providing knowledge exchange of testing personnel, and testing a process case to realize knowledge sharing and management through a plurality of stored test process logs.

The single chip microcomputer adopts an STM32F103ZET6. The AD acquisition module adopts an AD7606. The current transformer adopts a GY-712 hall sensor. The display module adopts a TFT_LCD. The photoelectric chip U13 adopts a TLP521. The voltage transforming chip U15 adopts an LM2596S. The voltage stabilizing chips U22 and U23 respectively adopt 4407A. The connecting terminal U21 adopts a Header 6. The charge-discharge protection chip U24 adopts an 8254AA.

The portable photovoltaic module V-I tester adopts separates mode of power supply and charging to drive the host. Two sets of USB ports are adopted to avoid charging the battery and supplying power to the host with only one USB port, which may lead to excessive current and reduce service life of components. One of the two USB ports is used to supply power to the VI tester and drive the host to work normally; the other one of the two USB ports is used to charge the battery. The power supply battery preferably adopts a lithium battery.

The portable photovoltaic module V-I tester may carry out voltage division calculation with automatic selection of gear range (0-50V, 0-100V) on an input voltage of a high-power photovoltaic module with a large measuring range, which may be applied in a safe measuring range, and improve measuring precision. The circuit principle design is concise, and the elements are reasonably laid out, such that the size of the device may be reduced significantly. The portable photovoltaic module V-I tester is portable. The display module adopts a 3.5-inch LCD screen and a membrane key panel, which is convenient for using and reading clearly; the host is provided with an infrared temperature sensor which may assist the host to perform temperature correction, thereby improving measuring precision.

The embodiments described in this specification are described in a progressive manner, and each embodiment focuses on differences from that of the other embodiments. Identical or similar parts among each embodiment may be referred to each other.

The terms “first”, “second”, “third” and “fourth” (if any) in the specification and claims of the present disclosure and the drawings above are merely used to distinguish similar objects and does not intend to limit a particular order or sequence. It should be understood that the sequence number used herein may be interchangeable where appropriate so that embodiments of the present invention described herein can be implemented in a sequence other than those illustrated or described herein. In addition, the terms “include” and “have” and any transformation thereof are intended to be of non-exclusive meaning.

The above description of the disclosed embodiments enables those skilled in the field to realize or utilize the present application. A variety of modifications to these embodiments will be apparent for those skilled in the field. The general principles defined herein may be implemented in alternative embodiments without departing from the spirit or scope of the present application. Therefore, the present application should not be limited to the embodiments illustrated herein, but shall conform to a maximum scope consistent with the principles and novel features disclosed herein.

What is claimed is:

1. A portable photovoltaic module V-I tester, wherein the portable photovoltaic module V-I tester comprises a host including a power unit and a control unit; the control unit comprises a single chip microcomputer, an AD acquisition module and a display module; the power unit comprises a power supply module, a charging module and a power supply battery for supplying power to an internal element of the tester;
the power supply module and the charging module are respectively electrically connected to the power supply battery; the power supply module is connected to a power supply end of the power supply battery; the power supply module is configured to transform and stabilize a power supply voltage of the power supply battery; the charging module is connected to a charging end of the power supply battery; the charging module is configured to stabilize a charging voltage of the power supply battery;
the display module and the AD acquisition module are respectively connected to the single chip microcomputer; the AD acquisition module is configured to measure a voltage and a current of the photovoltaic module and transmit the value of the voltage and the current to the single chip microcomputer;
the single chip microcomputer receives data information collected by the AD acquisition module; screens and processes received data information; analyzes, collects statistics on and stores collected photovoltaic module data; compares the collected photovoltaic module data with a corresponding threshold; and outputs to the display module for displaying.

2. The portable photovoltaic module V-I tester of claim 1, wherein the portable photovoltaic module V-I tester further comprises a slave;
the host further comprises a host data communication module;
the slave comprises a slave data communication module, a slave processor and a slave storage module;
the slave data communication module is communicatively connected to the host data communication module for data exchange between the host and the slave;
the slave storage module is configured to store various standard parameters of solar photovoltaic module including light intensity, temperature data, current data and voltage data;
the slave processor is configured to transmit the standard parameters of the solar photovoltaic module to the host for analyzing and collecting statistics on the collected photovoltaic module data via a communicative connection between the slave data communication module and the host data communication module.

3. The portable photovoltaic module V-I tester of claim 1, wherein the control unit comprises a test circuit including a resistor R20, a resistor R21, a resistor R22, a resistor R23, a resistor R24, a first switch end, a second switch end, a third switch end, a fourth switch end, a fifth switch end, a first access end, a second access end, a third access end, a fourth access end, a current transformer, a capacitor C11, a normally open relay K1, a normally open relay K2, a normally open relay K3, a first output end and a second output end;
two ends of the normally open relay K1 are respectively connected to the first switch end and the second switch end; the third switch end and the fifth switch end are respectively connected to two ends of the normally open relay K2; the fourth switch end and the fifth switch end are respectively connected to two ends of the normally open relay K3;
the first access end, the first output end, the first switch end and a first end of the resistor R20 are connected together; a second end of the resistor R20, a second access end, a first end of the resistor R21 are connected together; a second end of the resistor R21, the second output end, a first pin of the current transformer are connected together; the second switch end, a first end of the capacitor C11, a first end of the resistor R22 and a first end of the resistor R23 are connected together; a second end of the capacitor C11, a second end of the resistor R23, the fourth access end, a second pin of the current transformer are connected together; a second end of the resistor R22 is connected to a third access end; a second end of the resistor R23 is connected to the fourth switch end; the fifth switch end, the third access end, a first end of the resistor R24 are connected together; a third pin of the current transformer is connected to the power supply; a fourth pin of the current transformer is connected to the AD acquisition module; the fifth pin of the current transformer is grounded.

4. The portable photovoltaic module V-I tester of claim 3, wherein the control unit further comprises a relay control unit;
the relay control unit, connected to the single chip microcomputer, comprises a first relay control circuit, a second relay control circuit and a third relay control circuit;
the first relay control circuit comprises a resistor R1, a resistor R2, a diode D1, a transistor Q1, a relay K1 control coil and a normally open relay K1;
an input end of the first relay control circuit is connected to the single chip microcomputer for receiving input control signal of the single chip microcomputer; a first end of the resistor R1 is connected to the input end of the first relay control circuit; a second end of the resistor R1 is connected to a first end of the resistor R2 and a base of the transistor Q1 respectively; a second end of the resistor R2 and an emitter of the transistor Q1 are grounded; a collector of the transistor Q1 is connected to a positive electrode of the diode D1 and a first end of the relay K1 control coil respectively; a negative electrode of the diode D1 and a second end of the relay K1 control coil are both connected to the power supply respectively; two ends of the normally open relay K1 are respectively connected to the first access end and the second access end;
the second relay control circuit comprises a resistor R3, a resistor R4, a diode D2, a transistor Q2, a relay K2 control coil and a normally open relay K2;
an input end of the second relay control circuit is connected to the single chip microcomputer for receiving input control signal of the single chip microcomputer; a first end of the resistor R3 is connected to the input end of the first relay control circuit; a second end of the resistor R3 is connected to a first end of the resistor R4 and a base of the transistor Q2 respectively; a second end of the resistor R4 and an emitter of the transistor Q2 are grounded; a collector of the transistor Q2 is connected to a positive electrode of the diode D2 and a first end of the relay K2 control coil respectively; a negative electrode of the diode D2 and a second end of the relay K2 control coil are connected to the power supply respectively; two ends of the normally open relay K2 are respectively connected to the third access end and the fifth access end;
the third relay control circuit comprises a resistor R5, a resistor R6, a diode D3, a transistor Q3, a relay K3 control coil and a normally open relay K3;
an input end of the third relay control circuit is connected to the single chip microcomputer for receiving input control signal of the single chip microcomputer; a first end of the resistor R5 is connected to the input end of the first relay control circuit; a second end of the resistor R5 is connected to a first end of the resistor R6 and a base of the transistor Q3 respectively; a second end of the resistor R5 and an emitter of the transistor Q3 are grounded; a collector of the transistor Q3 is connected to a positive electrode of the diode D3 and a first end of the relay K3 control coil respectively; a negative electrode of the diode D3 and a second end of the relay K3 control coil are connected to the power supply respectively in power connection; two ends of the normally open relay K3 are respectively connected to the fourth access end and the fifth access end.

5. The portable photovoltaic module V-I tester of claim 1, wherein the power supply module comprises a booster circuit and a step-down circuit;
the booster circuit comprises a booster chip U11, a resistor RP1, a resistor RP2, a resistor RP3, a resistor RP4, a capacitor CP1, a capacitor CP2, a capacitor CP3, a capacitor CP4, a capacitor CP5, a diode DP1, a diode DP2, an inductance LP1, and an inductance LP2;
an input end of the booster circuit is accessed to the power supply battery; a first end of capacitor CP1, a first end of the inductance LP1, a fifth pin of the booster chip U11 and an input end of the booster circuit are connected together; a second end of the capacitor CP1 is grounded; a first end of the capacitor CP5 is connected to a second end of the capacitor CP1; a second end of the capacitor CP5 is grounded; a second end of the inductance LP1, a fourth pin of the booster chip U11, and a positive electrode of the diode CP1 are connected together; a negative electrode of the diode DP1, a first end of the capacitor CP2, a first end of the capacitor CP3, a second end of the resistor RP4, a positive electrode of the diode DP2 are connected together; a second end of the capacitor CP2 is grounded; a second end of the capacitor CP3 is grounded; a negative electrode of the diode DP2 is connected to an output end of the booster circuit through the inductance LP2; a first pin of the booster circuit U11 is grounded through the resistor RP1 and the capacitor CP4; a third pin of the booster chip U11 is grounded; a second pin of the booster chip U11, a second end of the resistor RP2 and a first end of the resistor RP3 are connected together; a first end of the resistor RP2 is grounded; a second end of the resistor RP3 is connected to a first end of the resistor RP4;
the step-down circuit comprises a step-down chip U12, a capacitor CJ1, a capacitor CJ2, a capacitor CJ3, a diode DJ2, an inductance LJ1, a resistor RJ1, and a resistor RJ2;
an input end of the step-down circuit is accessed to a power supply battery; a first pin of the step-down chip U12 and a first end of the capacitor CJ1 are connected to an input end of the step-down circuit; a second end of the capacitor CJ1, a fifth pin, a third pin and a sixth pin of the step-down chip U12, a positive electrode of the diode DJ1, a second end of the capacitor CJ2, a second end of the resistor RJ2, and a second end of the capacitor CJ3 are all grounded; a second pin of the step-down chip U12 is connected to a negative electrode of the diode DJ1 and a first end of the inductance LJ1; a fourth pin of the step-down chip U12 is connected to a second end of the resistor RJ1 and a first end of the resistor RJ2 respectively; a second end of the inductance LJ1, a first end of the capacitor CJ2, a first end of the resistor RJ1, a first end of the capacitor CJ3, and a positive electrode of the diode DJ2 are connected together; a negative electrode of the diode DJ2 is connected to an output end of the step-down circuit.

6. The portable photovoltaic module V-I tester of claim 2, wherein the power supply module comprises a booster circuit and a step-down circuit;
the booster circuit comprises a booster chip U11, a resistor RP1, a resistor RP2, a resistor RP3, a resistor RP4, a capacitor CP1, a capacitor CP2, a capacitor CP3, a capacitor CP4, a capacitor CP5, a diode DP1, a diode DP2, an inductance LP1, and an inductance LP2;
an input end of the booster circuit is accessed to the power supply battery; a first end of capacitor CP1, a first end of the inductance LP1, a fifth pin of the booster chip U11 and an input end of the booster circuit are connected together; a second end of the capacitor CP1 is grounded; a first end of the capacitor CP5 is connected to a second end of the capacitor CP1; a second end of the capacitor CP5 is grounded; a second end of the inductance LP1, a fourth pin of the booster chip U11, and a positive electrode of the diode CP1 are connected together; a negative electrode of the diode DP1, a first end of the capacitor CP2, a first end of the capacitor CP3, a second end of the resistor RP4, a positive electrode of the diode DP2 are connected together; a second end of the capacitor CP2 is grounded; a second end of the capacitor CP3 is grounded; a negative electrode of the diode DP2 is connected to an output end of the booster circuit through the inductance LP2; a first pin of the booster circuit U11 is grounded through the resistor RP1 and the capacitor CP4; a third pin of the booster chip U11 is grounded; a second pin of the booster chip U11, a second end of the resistor RP2 and a first end of the resistor RP3 are connected together; a first end of the resistor RP2 is grounded; a second end of the resistor RP3 is connected to a first end of the resistor RP4;
the step-down circuit comprises a step-down chip U12, a capacitor CJ1, a capacitor CJ2, a capacitor CJ3, a diode DJ2, an inductance LJ1, a resistor RJ1, and a resistor RJ2;
an input end of the step-down circuit is accessed to a power supply battery; a first pin of the step-down chip U12 and a first end of the capacitor CJ1 are connected to an input end of the step-down circuit; a second end of the capacitor CJ1, a fifth pin, a third pin and a sixth pin of the step-down chip U12, a positive electrode of the diode DJ1, a second end of the capacitor CJ2, a second end of the resistor RJ2, a second end of the capacitor CJ3 are all grounded; a second pin of the step-down chip U12 is connected to a negative electrode of the diode DJ1 and a first end of the inductance LJ1; a fourth pin of the step-down chip U12 is connected to a second end of the resistor RJ1 and a first end of the resistor RJ2 respectively; a second end of the inductance LJ1, a first end of the capacitor CJ2, a first end of the resistor RJ1, a first end of the capacitor CJ3, and a positive electrode of the diode DJ2 are connected together; a negative electrode of the diode DJ2 is connected to an output end of the step-down circuit.

7. The portable photovoltaic module V-I tester of claim 1, wherein the power supply module comprises a voltage stabilizing circuit and a voltage transforming circuit;
the voltage stabilizing circuit comprises a resistor RU1, a resistor RU2, a resistor RU3, a resistor RU4, a resistor RU5, a capacitor CU1, a diode DU1, a diode DU2, a diode DU3, a diode DU4, a photoelectric chip U13, and a field-effect tube QU;
a positive electrode of the diode DU1 is connected to a 5V power supply; the diode DU2 is connected to the power supply; a negative electrode of the diode DU1 and a negative electrode of the diode DU2 are respectively connected to a first end of the resistor RU5; a second end of the resistor RU5 is connected to a first end of the capacitor CU1 and a first pin of the photoelectric chip U13 respectively; a second end of the capacitor CU1 and a second pin of the photoelectric chip U13 are grounded; a fourth pin of the photoelectric U13 is connected to a 12V power supply; a third pin of the photoelectric chip U13 is connected to a first end of the resistor RU1; a second end of the resistor RU1 is connected to a first end of the resistor RU2 and a first end of the field-effect tube QU respectively; a second end of the resistor RU2 is grounded; a second end of the filed-effect tube QU is connected to the 12V power supply and a first end of the resistor RU3 respectively; a third end of the field-effect tube QU is connected to a positive electrode of the diode DU3; a negative electrode of the diode DU3 and a negative electrode of the diode DU4 are respectively connected to an output end of the voltage stabilizing circuit; a positive electrode of the diode DU4 is connected to the 5V power supply; a second end of the resistor RU3 is grounded through the resistor RU4; two ends of the resistor RU4 are provided with a connecting end of the acquisition module;
the voltage transforming circuit comprises a voltage transforming chip U15, a capacitor CW1, a capacitor CW2, a capacitor CW3, a capacitor CW4 and an inductance LW;
a third pin of the voltage transforming chip U15, a first end of the capacitor CW1, and a first end of the capacitor CW2 are respectively accessed to an input end of the voltage transforming circuit; a fourth pin of the voltage transforming chip U15 is connected to a 3.3V power supply; a second pin of the voltage transforming chip U15 is connected to a first end of the capacitor CW2, a first end of the capacitor CW4 and a first end of the inductance LW respectively; a second end of the capacitor CW1, a second end of the capacitor CW2, a first pin of the voltage transforming chip U15, a second end of the capacitor CW3, and a second end of the capacitor CW4 are grounded; a second end of the inductance LW is connected to an output end of the voltage transforming circuit.

8. The portable photovoltaic module V-I tester of claim 2, wherein the power supply module comprises a voltage stabilizing circuit and a voltage transforming circuit;
the voltage stabilizing circuit comprises a resistor RU1, a resistor RU2, a resistor RU3, a resistor RU4, a resistor RU5, a capacitor CU1, a diode DU1, a diode DU2, a diode DU3, a diode DU4, a photoelectric chip U13, and a field-effect tube QU;
a positive electrode of the diode DU1 is connected to a 5V power supply; the diode DU2 is connected to the power supply; a negative electrode of the diode DU1 and a negative electrode of the diode DU2 are respectively connected to a first end of the resistor RU5; a second end of the resistor RU5 is connected to a first end of the capacitor CU1 and a first pin of the photoelectric chip U13 respectively; a second end of the capacitor CU1 and a second pin of the photoelectric chip U13 are grounded; a fourth pin of the photoelectric U13 is connected to a 12V power supply; a third pin of the photoelectric chip U13 is connected to a first end of the resistor RU1; a second end of the resistor RU1 is connected to a first end of the resistor RU2 and a first end of the field-effect tube QU respectively; a second end of the resistor RU2 is grounded; a second end of the filed-effect tube QU is connected to the 12V power supply and a first end of the resistor RU3 respectively; a third end of the field-effect tube QU is connected to a positive electrode of the diode DU3; a negative electrode of the diode DU3 and a negative electrode of the diode DU4 are respectively connected to an output end of the voltage stabilizing circuit; a positive electrode of the diode DU4 is connected the 5V power supply; a second end of the resistor RU3 is grounded through the resistor RU4; two ends of the resistor RU4 are provided with a connecting end of the acquisition module;
the voltage transforming circuit comprises a voltage transforming chip U15, a capacitor CW1, a capacitor CW2, a capacitor CW3, a capacitor CW4 and an inductance LW;
a third pin of the voltage transforming chip U15, a first end of the capacitor CW1, and a first end of the capacitor CW2 are respectively accessed to an input end of the voltage transforming circuit; a fourth pin of the voltage transforming chip U15 is connected to a 3.3V power supply; a second pin of the voltage transforming chip U15 is connected to a first end of the capacitor CW2, a first end of the capacitor CW4 and a first end of the inductance LW respectively; a second end of the capacitor CW1, a second end of the capacitor CW2, a first pin of the voltage transforming chip U15, a second end of the capacitor CW3, and a second end of the capacitor CW4 are grounded; a second end of the inductance LW is connected to an output end of the voltage transforming circuit.

9. The portable photovoltaic module V-I tester of claim 1, wherein the charging module comprises a charging voltage transforming circuit and a charging protection circuit;
the charging voltage transforming circuit comprises a resistor RB1, a resistor RB2, a resistor RB3, a resistor RB4, a resistor RB5, a resistor RB6, a capacitance CB1, a capacitance CB2, a capacitance CB3, a capacitance CB4, an inductance LB1, an inductance LB2, an inductance LB3, an inductance LB4, a charging voltage transforming chip U14, a diode DB1, a diode DB2, a diode DB3, a first charging access end J1 and a second charging access end J2;
a second pin of the first charging access end J1 is grounded; a first pin of the first charging access end J1 is connected to a first end of the inductance LB1; a second end of the inductance LB1, a second end of the resistor RB2, a first end of the capacitor CB1, a first end of the resistor LB2, and a fifth pin of the charging voltage transforming chip U14 are connected together; a first end of the resistor RB2 is grounded through the resistor RB1; two ends of the resistor RB1 are provided with a connecting end of the AD acquisition module; a second end of the inductance LB2 is grounded; a fourth pin of the charging voltage transforming chip U14 is connected to a positive electrode of the diode DB3; a negative electrode of the diode DB3, a first end of the capacitor CB3, a first end of the capacitor CB4, a second end of resistor RB6 and a positive electrode of the diode DB1 are connected together; a second end of the capacitor CB3 and a second end of the capacitor CB2 are respectively grounded; a third pin of the charging voltage transforming chip U14 is grounded; a first pin of the charging voltage transforming chip U14 is grounded through the resistor RB3 and the capacitor CB2; a second pin of the charging voltage transforming chip U14 is connected to a second end of the resistor RB4 and a first end of the resistor RB5; a first end of the resistor RB4 is grounded; a second end of the resistor RB5 is connected to a first end of the resistor RB6; a negative electrode of the diode DB1 is connected to a first end of inductance LB3; a second end of the inductance LB3 is connected to a positive electrode of the diode DB2 through the inductance LB4; a negative electrode of the diode DB2 is accessed to a second pin of the second charging access end J2; a first pin of the second charging access end J2 is grounded;
the charging protection circuit comprises a connecting terminal U21, a voltage stabilizing chip U22, a voltage stabilizing chip U23, a charge-discharge protection chip U24, a charging protection resistor R1, a charging protection resistor R2, a charging protection resistor R3, a charging protection resistor R4, a charging protection resistor R5, a charging protection resistor R6, a charging protection resistor R7, a charging protection resistor R8, a charging protection resistor R9, a charging protection resistor R10, a charging protection resistor R11, a charging protection capacitor C1, a charging protection capacitor C3, a charging protection capacitor C4, a charging protection capacitor C5 and a charging protection capacitor C6;
a first pin of the connecting terminal U21 is connected to an input power of the charging protection circuit, a first pin, a second pin and third pin of the voltage stabilizing chip U23, a first end of the charging protection resistor R5 and a first end of the charging protection resistor R6 respectively; a second pin and a fourth pin of the connecting terminal U21, a first end of the charging protection resistor R9 and a first end of the charging protection resistor R10 are respectively grounded; a third pin of the connecting terminal U21, a first pin, a second pin, a third pin of the voltage stabilizing chip U22 and a first end of the charging protection capacitor C6 are connected together; a fifth pin of connecting terminal U21 is connected to a first end of the charging protection resistor R2; a sixth pin of the connecting terminal U21 is connected to a first end of the charging protection capacitor C3 and a first end of the charging protection resistor R3 respectively; a fourth pin of the voltage stabilizing chip U22 is connected to a first end of the charging protection resistor R7; a fourth pin of the voltage stabilizing chip U23 is connected to a second end of the charging protection resistor R5 and a first pin of the charge-discharge protection chip U24 respectively; a second end of the charging protection resistor R6 is connected to a second pin of the charge-discharge protection chip U24; a third pin of the charge-discharge protection chip U24 is connected to a second end of the charging protection resistor R7; a fourth pin of the charge-discharge protection chip U24 is connected to a second end of the charging protection resistor R9; a fifth pin of the charge-discharge protection chip U24 is connected to a second end of the charge-discharge protection capacitor C4; a first end of capacitor C4, a second end of charging protection resistor R10, a first end of capacitor C5, a second end of the charging protection resistor R11, a second end of charging protection resistor R4, and 12th pin of the charge-discharge protection chip U24 are connected together; a sixth pin of charge-discharge protection chip U24 is connected to a second end of the charging protection capacitor C5; a seventh pin of the charge-discharge protection chip U24 is connected to a second end of the charge-discharge protection capacitor C6; a 10th pin of the charge-discharge protection chip U24 is connected to a first end of the charging protection resistor R11; a 11th pin of the charge-discharge protection chip U24 is connected to a first end of the charging protection resistor R4; a 13th pin of the charge-discharge protection chip U24 is connected to a second end of the charging protection resistor R3; a second end of the charging protection resistor R3, and the 14th pin of the charge-discharge protection chip U24 are connected to a second end of the charging protection resistor R2; a 15th pin of the charge-discharge protection chip U24 is connected to a first end of the charging protection resistor R1 and a first end of the charging protection capacitor C1 respectively; a 16^{th} pin of U24 is connected to a second end of the charging protection resistor R1, a second end of the charging protection capacitor C1 and a second end of charging protection capacitor C3 respectively.

10. The portable photovoltaic module V-I tester of claim 2, wherein the charging module comprises a charging voltage transforming circuit and a charging protection circuit;
the charging voltage transforming circuit comprises a resistor RB1, a resistor RB2, a resistor RB3, a resistor RB4, a resistor RB5, a resistor RB6, a capacitance CB1, a capacitance CB2, a capacitance CB3, a capacitance CB4, an inductance LB1, an inductance LB2, an inductance LB3, an inductance LB4, a charging voltage transforming chip U14, a diode DB1, a diode DB2, a diode DB3, a first charging access end J1 and a second charging access end J2;
a second pin of the first charging access end J1 is grounded; a first pin of the first charging access end J1 is connected to a first end of the inductance LB1; a second end of the inductance LB1, a second end of the resistor RB2, a first end of the capacitor CB1, a first end of the resistor LB2, and a fifth pin of the charging voltage transforming chip U14 are connected together; a first end of the resistor RB2 is grounded through the resistor RB1; two ends of the resistor RB1 are provided with a connecting end of the AD acquisition module; a second end of the inductance LB2 is grounded; a fourth pin of the charging voltage transforming chip U14 is connected to a positive electrode of the diode DB3; a negative electrode of the diode DB3, a first end of the capacitor CB3, a first end of the capacitor CB4, a second end of resistor RB6 and a positive electrode of the diode DB1 are connected together; a second end of the capacitor CB3 and a second end of the capacitor CB2 are respectively grounded; a third pin of the charging voltage transforming chip U14 is grounded; a first pin of the charging voltage transforming chip U14 is grounded through the resistor RB3 and the capacitor CB2; a second pin of the charging voltage transforming chip U14 is connected to a second end of the resistor RB4 and a first end of the resistor RB5; a first end of the resistor RB4 is grounded; a second end of the resistor RB5 is connected to a first end of the resistor RB6; a negative electrode of the diode DB1 is connected to a first end of inductance LB3; a second end of the inductance LB3 is connected to a positive electrode of the diode DB2 through the inductance LB4; a negative electrode of the diode DB2 is accessed to a second pin of the second charging access end J2; a first pin of the second charging access end J2 is grounded;
the charging protection circuit comprises a connecting terminal U21, a voltage stabilizing chip U22, a voltage stabilizing chip U23, a charge-discharge protection chip U24, a charging protection resistor R1, a charging protection resistor R2, a charging protection resistor R3, a charging protection resistor R4, a charging protection resistor R5, a charging protection resistor R6, a charging protection resistor R7, a charging protection resistor R8, a charging protection resistor R9, a charging protection resistor R10, a charging protection resistor R11, a charging protection capacitor C1, a charging protection capacitor C3, a charging protection capacitor C4, a charging protection capacitor C5 and a charging protection capacitor C6;
a first pin of the connecting terminal U21 is connected to an input power of the charging protection circuit, a first pin, a second pin and third pin of the voltage stabilizing chip U23, a first end of the charging protection resistor R5 and a first end of the charging protection resistor R6 respectively; a second pin and a fourth pin of the connecting terminal U21, a first end of the charging protection resistor R9 and a first end of the charging protection resistor R10 are respectively grounded; a third pin of the connecting terminal U21, a first pin, a second pin, a third pin of the voltage stabilizing chip U22 and a first end of the charging protection capacitor C6 are connected together; a fifth pin of connecting terminal U21 is connected to a first end of the charging protection resistor R2; a sixth pin of the connecting terminal U21 is connected to a first end of the charging protection capacitor C3 and a first end of the charging protection resistor R3 respectively; a fourth pin of the voltage stabilizing chip U22 is connected to a first end of the charging protection resistor R7; a fourth pin of the voltage stabilizing chip U23 is connected to a second end of the charging protection resistor R5 and a first pin of the charge-discharge protection chip U24 respectively; a second end of the charging protection resistor R6 is connected to a second pin of the charge-discharge protection chip U24; a third pin of the charge-discharge protection chip U24 is connected to a second end of the charging protection resistor R7; a fourth pin of the charge-discharge protection chip U24 is connected to a second end of the charging protection resistor R9; a fifth pin of the charge-discharge protection chip U24 is connected to a second end of the charge-discharge protection capacitor C4; a first end of capacitor C4, a second end of charging protection resistor R10, a first end of capacitor C5, a second end of the charging protection resistor R11, a second end of charging protection resistor R4, and 12th pin of the charge-discharge protection chip U24 are connected together; a sixth pin of charge-discharge protection chip U24 is connected to a second end of the charging protection capacitor C5; a seventh pin of the charge-discharge protection chip U24 is connected to a second end of the charge-discharge protection capacitor C6; a 10th pin of the charge-discharge protection chip U24 is connected to a first end of the charging protection resistor R11; a 11^{th} pin of the charge-discharge protection chip U24 is connected to a first end of the charging protection resistor R4; a 13^{th} pin of the charge-discharge protection chip U24 is connected to a second end of the charging protection resistor R3; a second end of the charging protection resistor R3, and the 14^{th} pin of the charge-discharge protection chip U24 are connected to a second end of the charging protection resistor R2; a 15th pin of the charge-discharge protection chip U24 is connected to a first end of the charging protection resistor R1 and a first end of the charging protection capacitor C1 respectively; a 16th pin of U24 is connected to a second end of the charging protection resistor R1, a second end of the charging protection capacitor C1 and a second end of charging protection capacitor C3 respectively.

11. The portable photovoltaic module V-I tester of claim 2, wherein the host further comprises a host six-axis gyroscope, and a sun angle calculation module;
the sun angle calculation module is configured to calculate values of a sun altitude angle and a sun azimuth angle through a sun position algorithm after entering a sun trajectory tracking program; and based on the values of the sun altitude angle and the sun azimuth angle, an angle to be adjusted by the host six-axis gyroscope is calculated;
the host six-axis gyroscope is configured to adjust an angle of sunlight obtained by the host;
the slave comprises a slave six-axis gyroscope;
the slave six-axis gyroscope is configured to adjust an angle of sunlight obtained by the slave, and transmit the angle of sunlight obtained by the slave to the host for revising the angle of sunlight obtained by the host.

12. The portable photovoltaic module V-I tester of claim 1, wherein the host further comprises an infrared temperature sensor, a USB charging interface, a USB power supply interface and a data storage module;
the infrared temperature sensor is connected to the single chip microcomputer; the infrared temperature sensor is configured to sense a light intensity and transmit the light intensity, which is sensed, to the single chip microcomputer;
the USB charging interface is connected to the power supply battery through the charging module; the USB charging interface is configured to charge the power supply battery through a connection with an external power supply;
the USB power supply interface is connected to the power supply battery through the power supply module; the USB power supply interface is configured to enable the power supply battery to supply power to other devices;
the data storage module is configured to store the data information collected by the AD acquisition module and the data information of the photovoltaic module data analyzed and statistically collected by the single chip microcomputer.

13. The portable photovoltaic module V-I tester of claim 2, wherein the host further comprises an infrared temperature sensor, a USB charging interface, a USB power supply interface and a data storage module;
the infrared temperature sensor is connected to the single chip microcomputer; the infrared temperature sensor is configured to sense an intensity and transmit the intensity, which is sensed, to the single chip microcomputer;
the USB charging interface is connected to the power supply battery through the charging module; the USB charging interface is configured to charge the power supply battery through a connection with an external power supply;
the USB power supply interface is connected to the power supply battery through the power supply module; the USB power supply interface is configured to enable the power supply battery to supply power to other devices;
the data storage module is configured to store the data information collected by the AD acquisition module and the data information of the photovoltaic module data analyzed and statistically collected by the single chip microcomputer.

14. A photovoltaic module test system, wherein the photovoltaic module test system comprises a photovoltaic module V-I tester and a plurality of mobile terminals connected to the photovoltaic module V-I tester;
the photovoltaic module V-I tester comprises a data sharing platform;
the mobile terminals comprise clients;
the data sharing platform is configured to issue the data information stored by the photovoltaic module V-I tester, and be connected with the clients of the mobile terminals, enabling the mobile terminals to obtain data information stored by the data sharing platform, providing the knowledge exchange of testing personnel, and testing a process case to realize knowledge sharing and management through a plurality of stored test process logs.
